(19) United States
(12) Patent Application Publication
(10) Pub. No.: US 2019/0087808 A1
(43) Pub. Date: Mar. 21, 2019

(54) QUICK ACCESS DISPLAY

(71) Applicant: VISA International Service Association, San Francisco, CA (US)

(72) Inventors: George PERRY, Oakland, CA (US); Margaret SZETO, Mountain View, CA (US); Jaesung PARK, Mountain View, CA (US); Kellen MANNION, San Francisco, CA (US); Yobel MUCHANG, Dubai (AE)

(21) Appl. No.: 16/082,789

(22) PCT Filed: Jun. 2, 2017
(86) PCT No.: PCT/US17/35810

§ 371 Date: Sep. 6, 2018

Related U.S. Application Data
(60) Provisional application No. 62/345,675, filed on Jun. 3, 2016.

(51) Int. Cl. G06Q 20/32; G06Q 20/40

(52) U.S. Cl. CPC G06Q 20/3221; G06Q 20/405; G06Q 20/3226; G06Q 20/3224; G06Q 20/4014

(57) ABSTRACT

Embodiments of the invention are directed to a method of quickly displaying available payment device accounts with an application on a mobile device without requiring a password from a user. In one embodiment, information displayed includes available balances and rewards associated with the payment device accounts. Embodiments of the invention allow a user to quickly see this information without having to enter his or her authentication credentials each and every time this information is needed. Embodiments of the invention can also be seen as more secure as other methods and systems as the user does not have to log into the actual application itself, which may contain sensitive information.

### CROSS-REFERENCES TO RELATED APPLICATIONS

The present application is an international application of and claims priority to U.S. Provisional Application 62/345,675, filed Jun. 3, 2016, entitled QUICK ACCESS DISPLAY. The entire content of the above application is hereby incorporated by reference for all purposes in its entirety.

### BACKGROUND

Current solutions for displaying account information typically involve a user providing both a username and a password or other authentication information to access the account information. However, requiring the user to provide both a username and password to merely view account information, such as an account balance, creates opportunities for fraudsters to steal the authentication or verification information provided by the user during a login attempt. Furthermore, users may wish to access account information in a variety of locations including brick and mortar storefronts which may provide network access that further provides another opportunity for insecure networks to leak or share passwords or authentication information of the user during a login attempt. Without a reliable way to access account information absent providing the username, password, and/or other authentication information, a user may be hesitant to complete transactions or unsure of the fund availability until an opportunity has already passed.

Embodiments of the invention address these and other problems, individually and collectively.

### BRIEF SUMMARY

Embodiments of the present invention relate to systems and methods for displaying available payment device accounts (e.g., payment card accounts) and their balances associated with an application on a mobile device without requiring a password for the application. In embodiments, a user may input a username associated with each payment device account to access available balances associated with the payment device amount absent the provisioning of a password. A user may further interact with the application by providing a password or other type of authentication information to enable the payment device account to be utilized to complete a transaction. For example, a user may wish to purchase a pair of tennis shoes from a shoe store but is unaware of which payment device account has the appropriate amount of funds to complete the purchase. The user may provide input or otherwise interact with an application on their associated mobile device or personal computing device that includes a username associated with a payment device account and in response be provided with the available account balance of the payment device account. Thereafter, the user may interact with the application to provide a password or other authentication information to enable the payment device account and mobile device to complete the transaction and purchase the shoes after selecting an appropriate payment device account.

Current systems lack a method for displaying or otherwise providing account balance or account information to a user, via an application, in response to the user providing minimal input (e.g., a username). Instead, a user usually has to provide a username and other associated account verification information for each payment device account in order to merely view available funds and/or other account information associated with the payment device account. Remembering multiple passwords for each payment device account can be a burden and lead to the user attempting to complete a transaction with a payment device account that does not have the appropriate amount of funds as a result of not being able to view the available funds. Furthermore, requiring a user to provide passwords or authentication information to merely view account information associated with a payment device account can lead to more opportunities for fraudsters to obtain or otherwise steal the private information of the user. Embodiments of the invention provide a number of technical advantages. Embodiments of the invention allow a user to quickly access payment device account information without having to enter his or her authentication credentials each and every time this information is needed. Embodiments of the invention can also be seen as more secure than other methods and systems currently in use as the user does not have to log into the actual application itself, which may contain sensitive information.

One embodiment of the invention is directed to a computer-implemented method comprising, receiving, by a computer system and from a mobile device, first login credentials in response to a user interacting with the mobile device. The first login credentials are utilized to login to an application associated with a set of payment device accounts. The computer-implemented method further comprises obtaining, by the computer system, a username but not a password included in the first login credentials; determining, by the computer system, a particular payment device account of the set of payment device accounts based at least in part on the first login credentials; and transmitting, by the computer system, to the mobile device, an account balance associated with the particular payment device account for display via the application to the user.

In some embodiments, the computer-implemented method further comprises displaying, by the application on the mobile device, an offer associated with the particular payment device account. The computer-implemented method further comprises receiving, by the computer system and from the mobile device, second login credentials for the application associated with the set of payment device accounts; obtaining the password included in the second login credentials, and enabling the particular payment device account to be utilized to complete a transaction based at least in part on obtaining the password. In embodiments, the set of payment device accounts are associated with a set of preferences specified by the user for the set of payment device accounts. The set of preferences may include an order of preference for each payment device account of the set of payment device accounts when completing a transaction. The set of preferences may further include corresponding item categories for each payment device account of the set of payment device accounts. The set of preferences may indicate a monetary limit for each payment device account of the set of payment device accounts when completing a transaction. In some embodiments, the computer-implemented method further comprises transmitting, to a merchant computer, payment account information for a subset of the set of payment device accounts thereby enabling the merchant computer to withdraw a monetary amount up to the corresponding monetary limit for each payment device account of the subset of payment device accounts to complete the transaction.

One embodiment of the invention is directed to a computer-implemented method comprising obtaining, by a mobile device, first input corresponding to login credentials for an application associated with a set of payment device accounts; identifying, by the mobile device, that a username but not a password is included in the first input; requesting, by the mobile device from a server computer, an account balance associated with a particular payment device account of the set of payment device accounts based at least in part on the first input; and displaying, by the mobile device via the application, the account balance associated with the particular payment device account.

One embodiment of the invention is directed to a computer server, comprising a processor; and memory including instructions that, when executed with the processor, cause the server computer to at least: receive, from an application of a mobile device, first login credentials that are utilized to login to the application that is associated with a set of payment device accounts; determine that a username but not a password are included in the first login credentials; identify a particular payment device account of the payment device accounts based at least in part on the first login credentials; and transmit, to the application for display, an account balance associated with the particular payment device account.

In embodiments, the instructions, when executed with the processor, further cause the server computer to at least receive; from the application of the mobile device, geographic location information associated with a location of the mobile device; determine an offer based at least in part on the geographic location information and the particular payment device account; and transmit, to the application of the mobile device, the offer. In embodiments, the instructions, when executed with the processor, further cause the server computer to at least maintain a set of preferences specified by a user associated with the mobile device for the set of payment device accounts, where the set of preferences identify monetary limitations for each payment device account of the set of payment device accounts corresponding to geographic locations. In embodiments, the instructions, when executed with the processor, further cause the server computer to at least transmit a certain amount of funds from the particular payment device account based at least in part on geographic location information associated with a transaction and the set of preferences.

These and other embodiments of the invention are described in further detail below.

### BRIEF DESCRIPTION OF THE DRAWINGS

FIG. 1 depicts an example system architecture of a transaction processing system for implementing at least some embodiments of the current disclosure;

FIG. 2 depicts a block diagram of a mobile device according to an embodiment of the disclosure;

FIG. 3 depicts example screens displayed by the mobile device according to an embodiment of the disclosure;

FIG. 4 depicts an example flow chart of an account balance feature, in accordance with at least one embodiment of the disclosure; and

FIG. 5 depicts an example of a wallet application module for implementing at least some embodiments of the current disclosure.

### DETAILED DESCRIPTION

Applications on mobile devices are increasingly being used by both consumers and merchants to conduct payment transactions. One such application is an application that maintains account information associated with payment devices and uses the account information to conduct transactions. The application may also need to provide the user with information such as available balances, rewards, offers, as well as any other functions specific to the payment device. Often times, a user would like to quickly see this information without having to enter any authentication credentials (e.g., a password) each and every time this information is needed.

Embodiments of the invention are directed to accessing a set of balances associated with payment device accounts, without requiring authentication credentials. For example, a user may be at a store and would like to use a digital payment device application to conduct a payment transaction rather than use an actual physical payment device such as a plastic credit card. The user might also like to quickly check the balances of his or her payment devices in order to decide on which form of payment to choose.

In another example, a user may use an application to check rewards and offers available for a given payment card. The user may be near a number of merchants and would like to be able to quickly look at their mobile device to see any offers in the area to decide the best merchant to make a purchase with his or her payment card based on the rewards and/or offers available.

Prior to discussing embodiments of the invention, descriptions of some terms may be helpful in understanding embodiments of the invention.

“Login credentials” includes data that can be utilized to access an online resource. For example, login credentials can include data that can be used by an application to gain access to a payment account device of a set of payment account devices. Login credentials can include a username, a username and password, and/or other authentication information such as biometric information, answers to provided questions, or other suitable verification or authentication data. “Biometric information” or “biometric data” includes data that can be utilized to uniquely identify an individual based upon one or more intrinsic physical or behavioral traits. For example, biometric data may include retinal scan and tracking data (i.e., eye movement and tracking where a user's eyes are focused).

A “mobile device” or “computer device” may comprise any suitable electronic device that may be operated by a user. Examples of an electronic device may include a mobile phone (cellular phone), PDAs, tablet computers, net books, wearable devices, laptop computers, personal music players, hand-held specialized readers, etc. Further examples of mobile devices or computer devices include wearable devices, such as smart watches, fitness bands, ankle bracelets, rings, earrings, etc. Examples of remote communication capabilities include using a mobile phone (wireless) network, wireless data network (e.g., 3G, 4G, or similar networks), Wi-FI, Wi-MAX, or any other communication medium that may provide access to a network such as the Internet or a private network. In embodiments, a mobile device or computer device can function as a payment device (e.g., a computer device that can store and be able to transmit payment credentials for a transaction).

An “application” or “wallet application” may include any suitable software for maintaining, storing, retrieving, and communicating payment credentials for a transaction. The application may be computer code or other data stored on a computer readable medium (e.g., memory element or secure element) that may be executable by a processor to complete a task. The application or wallet application may maintain one or more payment device accounts that each correspond to a different payment account of an issuer. For example, one payment device account may correspond to a personal bank of a user while another payment device account may correspond to a credit card organization such as VISA™. As described herein, the application or wallet application may be configured to communicate with a payment processing network, a wallet application server, and/or an issuer computer to receive or obtain an account balance associated with a selected or interacted payment device account. In some embodiments, a user may interact with the application by providing a username and password for a particular payment device account which will be verified with the issuer and/or payment processing network to enable the particular payment device account to be utilized to complete a transaction.

“Item categories” may include a set or a plurality of different categories of items. In some embodiments, each item category includes items with similar characteristics, price points, or other relationship according to any suitable categorization. For example, item categories may be categorized according to price, weight, manufacturer and/or producer, intended use, etc. As an illustrative example; a particular item category may be labeled swim accessories and may include goggles, flippers, floatation devices; or other suitable swimming accessories. “Geographic location information” may include information or data utilized to identify a physical location of a device and/or corresponding user within a real world environment. An example of geographic location information may include GPS coordinates, Global navigation satellite system (GLONASS), Galileo, Beidou, etc. In some embodiments, a mobile device or computer device may be configured to obtain GPS coordinates and communicate such information to the wallet application server, payment processing network, and/or issuer computer for authentication or offer generation purposes.

An “access device” can include a device that allows for communication with a remote computer. In some embodiments, an access device can include a device that enables a user to make a payment to a merchant in exchange for goods or services. An access device can include hardware, software, or a combination thereof. Examples of access devices include point-of-sale (POS) terminals, mobile phones, tablet computers, laptop or desktop computers, user device computers, user devices; etc.

A “user” may include an individual. In some embodiments, a user may be associated with one or more personal accounts, payment device accounts, computing devices, and/or mobile devices. The user may also be referred to as a cardholder; account holder, or consumer in some embodiments.

A “merchant” may typically be an entity that engages in transactions and can sell goods or services, or provide access to goods or services. A merchant may operate a merchant computer for engaging in transactions to sell goods or services or provide access to goods or services.

An “acquirer” may typically be a business entity (e.g., a commercial bank) that has a business relationship with a particular merchant or other entity. Some entities can perform both issuer and acquirer functions. Some embodiments may encompass such single entity issuer-acquirers. An acquirer may operate an acquirer computer, which can also be generically referred to as a “transport computer.”

An “issuer” may typically refer to a business entity (e.g., a bank) that maintains an account for a user. An issuer may also issue payment credentials stored on a user device, such as a cellular telephone, mobile device, smart card, tablet, or laptop to the consumer.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may comprise one or more computational apparatuses and may use any of a variety of computing structures, arrangements, and compilations for servicing the requests from one or more client computers.

A “payment processing network” (e.g., VisaNet™) may include data processing subsystems, networks, and operations used to support and deliver authorization services, exception file services, and clearing and settlement services. An exemplary payment processing network may include VisaNet™. Payment processing networks such as VisaNet™ are able to process credit card transactions, debit card transactions, and other types of commercial transactions. VisaNet™ in particular, includes a VIP system (Visa Integrated Payments System) which processes authorization requests and a Base II system which performs clearing and settlement services. A payment processing network may be referred to as a processing network computer.

An “authorization request message” may be an electronic message that requests authorization for a transaction. In some embodiments, it is sent to a transaction processing computer and/or an issuer of a payment card to request authorization for a transaction. An authorization request message according to some embodiments may comply with ISO 8583, which is a standard for systems that exchange electronic transaction information associated with a payment made by a user using a payment device or payment account. The authorization request message may include an issuer account identifier that may be associated with a payment device or payment account. An authorization request message may also comprise additional data elements corresponding to “identification information” including, by way of example only: a service code, a CVV (card verification value), a dCVV (dynamic card verification value), a PAN (primary account number or “account number”), a payment token, a user name, an expiration date, etc. An authorization request message may also comprise “transaction information,” such as any information associated with a current transaction, such as the transaction amount, merchant identifier, merchant location, acquirer bank identification number (BIN), card acceptor ID, information identifying items being purchased, etc., as well as any other information that may be utilized in determining whether to identify and/or authorize a transaction.

An “authorization response message” may be a message that responds to an authorization request. In some cases, it may be an electronic message reply to an authorization request message generated by an issuing financial institution or a transaction processing computer. The authorization response message may include, by way of example only, one or more of the following status indicators: Approval—transaction was approved; Decline—transaction was not approved; or Call Center response pending more information, merchant must call the toll-free authorization phone number. The authorization response message may also include an authorization code, which may be a code that a credit card issuing bank returns in response to an authorization request message in an electronic message (either directly or through the transaction processing computer) to the merchant's access device (e.g. POS equipment) that indicates approval of the transaction. The code may serve as proof of authorization.

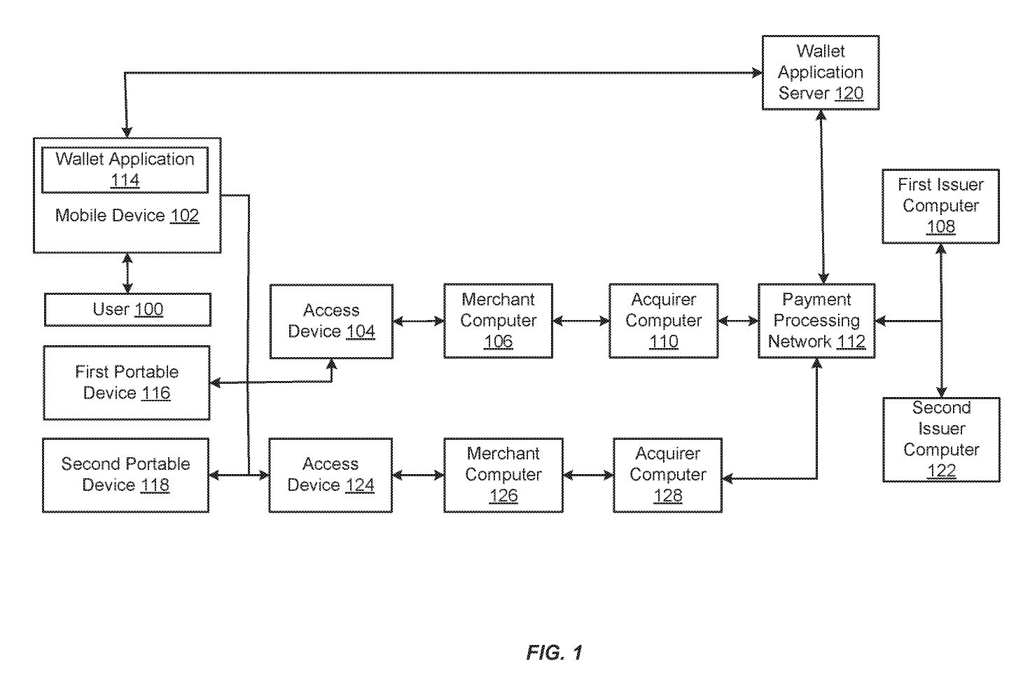

FIG. 1 illustrates a block diagram of a transaction processing system that can use a mobile device with access data such as data granting access to a payment device. FIG. 1 shows a user 100 that can operate a mobile device 102. The user 100 may use the mobile device 102 to pay for a good or service at a merchant. The merchant may operate an access device 104 and/or merchant computer 106. The merchant may communicate with a first issuer computer 108 via an acquirer computer 110 and a payment processing network 112.

The payment processing network 112 may include data processing subsystems, networks, and operations used to support and deliver authorization services, exception file services, and clearing and settlement services. An exemplary payment processing network may include VisaNet™, Payment processing networks such as VisaNet™ are able to process credit card transactions, debit card transactions, and other types of commercial transactions. VisaNet™, in particular, includes a VIP system (Visa Integrated Payments system) which processes authorization requests and a Base II system which performs clearing and settlement services. The payment processing network may use any suitable wired or wireless network, including the Internet.

A typical payment transaction flow using mobile device 102 at access device 104 (e.g. POS location) can be described as follows. A user 100 presents his or her mobile device 102 to access device 104 to pay for an item or service. The mobile device 102 and the access device 104 interact such that access data from the mobile device 102 (e.g. PAN, a payment token, verification value(s), expiration date, etc.) is received by the access device 104 (e.g. via contact or contactless interface). The merchant computer 106 may then receive this information from the access device 104 via an external communication interface. The merchant computer 106 may then generate an authorization request message that includes the information received from the access device 104 (i.e. information corresponding to the mobile device 102) along with additional transaction information (e.g. a transaction amount, merchant specific information, etc.) and electronically transmits this information to acquirer computer 110. The acquirer computer 110 may then receive, process, and forward the authorization request message to a payment processing network 112 for authorization.

In general, prior to the occurrence of a credit or debit-card transaction, the payment processing network 112 has an established protocol with each issuer on how the issuer's transactions are to be authorized. In some cases, such as when the transaction amount is below a threshold value, the payment processing network 112 may be configured to authorize the transaction based on information that it has about the users account without generating and transmitting an authorization request message to the first issuer computer 108. In other cases, such as when the transaction amount is above a threshold value, the payment processing network 112 may receive the authorization request message, determine the issuer associated with the mobile device 102, and forward the authorization request message for the transaction to the first issuer computer 108 for verification and authorization. Once the transaction is authorized, the first issuer computer 108 may generate an authorization response message (that may include an authorization code indicating the transaction is approved or declined) and transmit this electronic message via its external communication interface to payment processing network 112. The payment processing network 112 may then forward the authorization response message to the acquirer computer 110, which in turn may then transmit the electronic message to comprising the authorization indication to the merchant computer 106, and then to the access device 104.

At the end of the day or at some other suitable time interval, a clearing and settlement process between the merchant computer 106, the acquirer computer 110, the payment processing network 112, and the first issuer computer 108 may be performed on the transaction.

In accordance with at least one embodiment, prior to the completion of the typical transaction flow described above, the user 100 may interact with the mobile device 102 and wallet application 114 to obtain an account balance or account information associated with a set of payment account devices such as first portable device 116 and second portable device 118. In FIG. 1, the first portable device 116 may correspond to one payment account device while second portable device 118 may correspond to another payment account device of a plurality of payment account devices associated with the wallet application 114. In embodiments, the user 100 may interact with mobile device 102, wallet application 114, and wallet application server 120, to set-up or initialize a payment account device with the wallet application 114. During the set-up or initialize phase of the disclosure, the user, utilizing the wallet application 114 and mobile device 102, may provide a username, password, and/or other authentication information to the wallet application server 120. Thereafter, the user 100 may provide a username in the wallet application 114 which communicates a request for an account balance to the wallet application server 120 via available networks. The wallet application server 120 may communicate with the payment processing network 112 to identify an appropriate entity (issuer computer) to obtain the account balance associated with the corresponding payment account device included in the request (e.g., first issuer computer 108 or second issuer computer 122). The wallet application server 120 may provide the account balance to the wallet application 114 for display to the user 100 via mobile device 102 in response to receiving the account balance or account information from the appropriate entity (first issuer computer 108 or second issuer computer 122). In such embodiments, a payment account device may have a unique username and correspond to a particular issuer computer (i.e., first issuer computer 108 or second issuer computer 122).

As an illustrative example, the user 100 may interact with wallet application 114 of mobile device 102 to provide a username but not a password for the first portable device 116 (a first payment device account) that corresponds to the first issuer computer 108. The user 100 may wish to purchase an item from a merchant, such as a merchant associated with merchant computer 106 and access device 104, but needs to know an available account balance for one or more payment device accounts. The wallet application 114 may communicate the account balance request to the wallet application server 120 which may in turn communicate with the payment processing network 112 to identify the appropriate entity. In embodiments, the payment processing network 112 and/or the wallet application server 120 may perform a look-up operation in a database to identify a corresponding entity for a payment account device based on the login credentials or username provided by the user 100. For example, each payment account device may be associated with unique login credentials (i.e., username and password) that are maintained by the wallet application server 120 and/or payment processing network 112. Upon determining the appropriate issuer computer to communicate with, the payment processing network 112 may request an account balance from the first issuer computer 108 or the second issuer computer 122. In some embodiments, the appropriate issuer computer may identify or generate an offer to incentivize the user 100 to utilize the associated payment account device to complete a transaction. The wallet application server 120 may transmit the account balance provided by the appropriate issuer computer and/or payment processing network 112 for display via the wallet application 114 and mobile device 102 to the user 100. If an offer has been generated it will also be displayed via similar mechanism along with the account balance for the corresponding payment account device.

In accordance with at least one embodiment, the user 100 may interact with the wallet application 114 and mobile device 102 to request an account balance of a different payment account device such as second portable device 118 (which may correspond to a personal bank debit card or credit card). The user 100 may provide login credentials that correspond to a username for the second portable device 118. The wallet application 114 may request an account balance from the wallet application server 120, payment processing network 112, and either the second issuer computer 122. For example, the second portable device 118 may correspond to an account maintained by the second issuer computer 112. The wallet application server 120 may determine or identify the appropriate entity to request the account balance, in this case the second issuer computer 122, based on the login credentials provided by the user 100. In response, the wallet application 114 may transmit the account balance for display via the wallet application 114 and mobile device 102 to the user 100. Upon seeing the available balance or account balance for the second portable device 118, the user 100 may interact with the wallet application 114 and mobile device 102 to select the appropriate payment account device and provide further login credentials that may include a password or other authentication information associated with the payment account device (i.e., second portable device 118).

In some embodiments, the wallet application 114 again communicates with the wallet application server 120 and/or payment processing network 112 to obtain the appropriate credentials, thereby enabling the mobile device 102 to be utilized by the user 100 to complete a transaction. For example, the first issuer computer 108 and/or second issuer computer 122 that corresponds to the second portable device 118 may generate and transmit one or more tokens or other data to the mobile device 102, thereby enabling the user 100 to utilize the mobile device 102 to complete the transaction.

Thereafter, the user 100 presents his or her mobile device 102 to access device 124 to pay for an item or service offered by a merchant associated with merchant computer 126. The mobile device 102 and the access device 124 interact such that access data from the mobile device 102 (e.g. PAN, a payment token, verification value(s), expiration date, etc.) is received by the access device 124 (e.g. via contact or contactless interface). The merchant computer 126 may then receive this information from the access device 124 via an external communication interface. The merchant computer 126 may then generate an authorization request message that includes the information received from the access device 124 (i.e. information corresponding to the mobile device 102) along with additional transaction information (e.g. a transaction amount, merchant specific information, etc.) and electronically transmits this information to acquirer computer 128. The acquirer computer 128 may then receive, process, and forward the authorization request message to a payment processing network 112, and the first issuer computer 108 and the second issuer computer 122 for authorization. If the first issuer computer 108 or the second computer 122 authorize the transaction, a clearing and settlement process can occur at a later date. In some embodiments, the wallet application 114 communicates directly with the merchant computer 126 to provide the access data from the mobile device 102. In still other embodiments, the issuer computers 108 and 122 communicate with the merchant computer 106 or 126 to provide the access data.

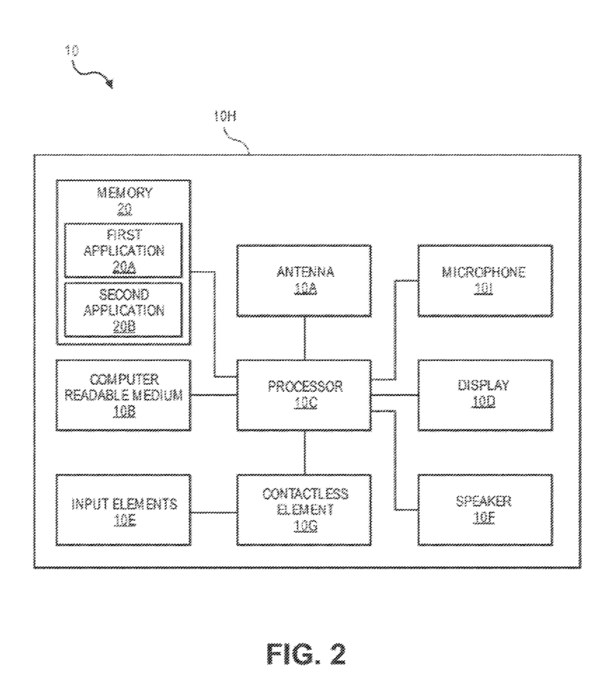

FIG. 2 shows a block diagram of a mobile device 10 according to an embodiment of the invention. The exemplary mobile device 10 may comprise a computer readable medium 10B that be present within the body 10H of the mobile device 10. The computer readable medium 10B may be in the form of a memory that stores data. The computer readable medium 10B may comprise code executable by the processor for implementing a method. The body 10H may be in the form a plastic substrate, housing, or other structure.

In some embodiments, the mobile device 10 may further include a contactless element 10G, which is typically implemented in the form of a semiconductor chip (or other data storage element) with an associated wireless transfer (e.g., data transmission) element, such as an antenna. Contactless element 10G may be coupled to (e.g., embedded within) the mobile device 10 and data or control instructions that are transmitted via a cellular network may be applied to the contactless element 10G by means of a contactless element interface (not shown). Contactless element 10G may be capable of transferring and receiving data using a short range wireless communication capability. As noted above, mobile device 10 may comprise components to both be the interrogator device (e.g. receiving data) and the interrogated device (e.g. sending data). Thus, the mobile device 10 may be capable of communicating and transferring data or control instructions via both cellular network (or any other suitable wireless network—e.g. the Internet or other data network) and short range communications.

The mobile device 10 may also include a processor 10C (e.g., a microprocessor) for processing the functions of the mobile device 10 and a display 10D to allow a consumer to see phone numbers and other information and messages. The mobile device 10 may further include input elements 10E to allow a user to input information into the device, a speaker 10F to allow the user to hear voice communication, music, etc., and a microphone 10I to allow the user to transmit her voice through the mobile device 10. The mobile device 10 may also include an antenna 10A for wireless data transfer (e.g., data transmission).

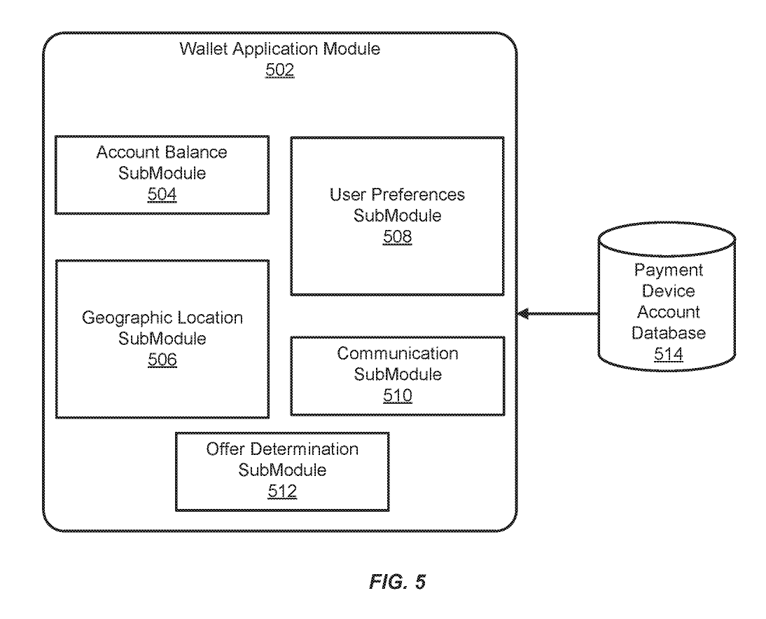

A memory 20 may be coupled to the processor 10C and may store applications such as first application 20A and a second application 20B. In some embodiments, the memory 20 in the mobile device 10 may also include a secure storage area for storing sensitive data such as payment credentials (account numbers, payment tokens, verification values, etc.) and access data. For example, the memory 20 may be part of or may contain a secure element. In accordance with at least one embodiment, the memory 20 may include one or more modules for implementing the features of the present disclosure as discussed further with reference to FIG. 5.

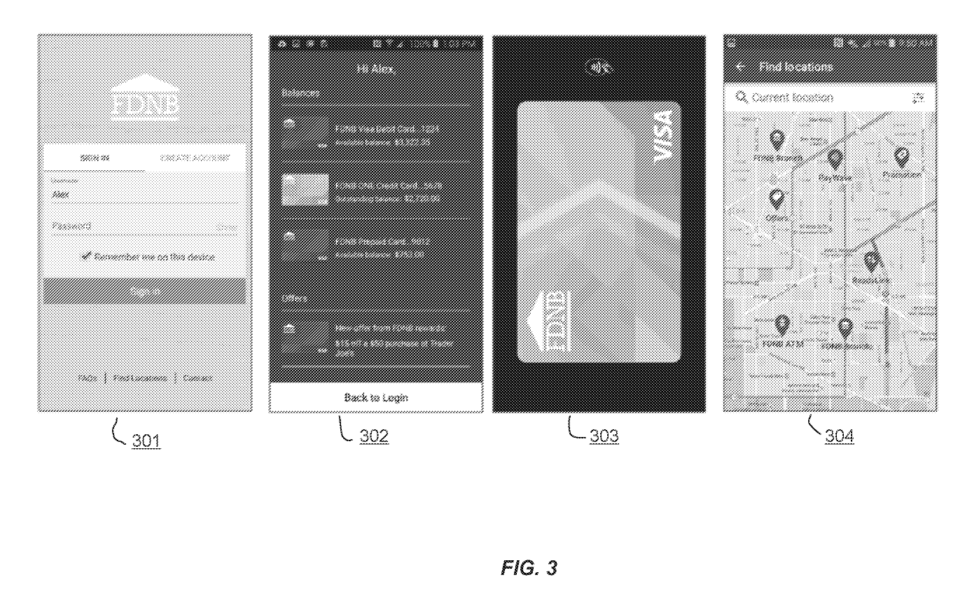

FIG. 3 shows graphical user interfaces according to one embodiment of the invention. The screens shown are different displays that appear to the user according to embodiments of the invention. At some point in time, the user will have earlier logged into the application using their complete username and password to identify himself or herself to the application. At a later point in time, the application may log out the user (e.g., because a transaction is complete or because time has expired).

The first screen 301 is the pre-login screen where the user enters his or her username. In one embodiment, the user can have his or her username auto-filled upon opening of the application by clicking the “Remember me on this device” check box. Once the user's username (but not his or her password) has been entered, screen 302 may be displayed. The screen 302 may instantly replace screen 301 after the username is entered. In another embodiment, the mobile device's display is a touchscreen that can accept the user's touch as input, and the user can switch between screens 301 and 302 by swiping his or her finger either left or right across the mobile device's touchscreen.

Screen 302 is an example of a service that may be provided by an application according to one embodiment of the invention. Screen 302 is a display of the users various payment devices and associated payment accounts. The display contains such information as an image or icon of the physical payment device (i.e. card), the name of the card, the last four digits of the payment account associated with the card, the available and/or outstanding balance of the card and/or payment account as well as a listing of any offers associated with the card. Using screen 302, the user may quickly check if a particular payment device has a large enough available balance to make a specific purchase.

Once the user has decided to use a payment device for a purchase; the user may enter his or her password in the application. Once the user is authenticated by the application and the user has selected a payment device, the mobile device may switch to screen 303 to activate the device for payment. In one embodiment, the user switches from screen 302 to screen 303 by selecting an image of one of the payment devices as displayed on screen 302. In one embodiment, the transition from screen 302 to screen 303 is completed by an animation of a payment card icon as shown on screen 302 expanding and rotating to the size and orientation of the payment card as shown on screen 303. Once screen 303 is displayed on the mobile device, the mobile device may now make payment transactions using the selected card. In one embodiment, the user makes a payment using the card displayed on screen 303 by holding the mobile device up to a merchant's access device or POS terminal. The mobile device then wirelessly communicates payment account information associated with the displayed card through the mobile device's antenna or contactless element to the access device as described with reference to FIG. 1.

Screen 304 shows another display according to an embodiment of the invention. The display includes a map that contains icons corresponding to the various card specific functions of a given payment device. Examples of card specific functions include Offers, Promotions, ATMs, and PayWave.

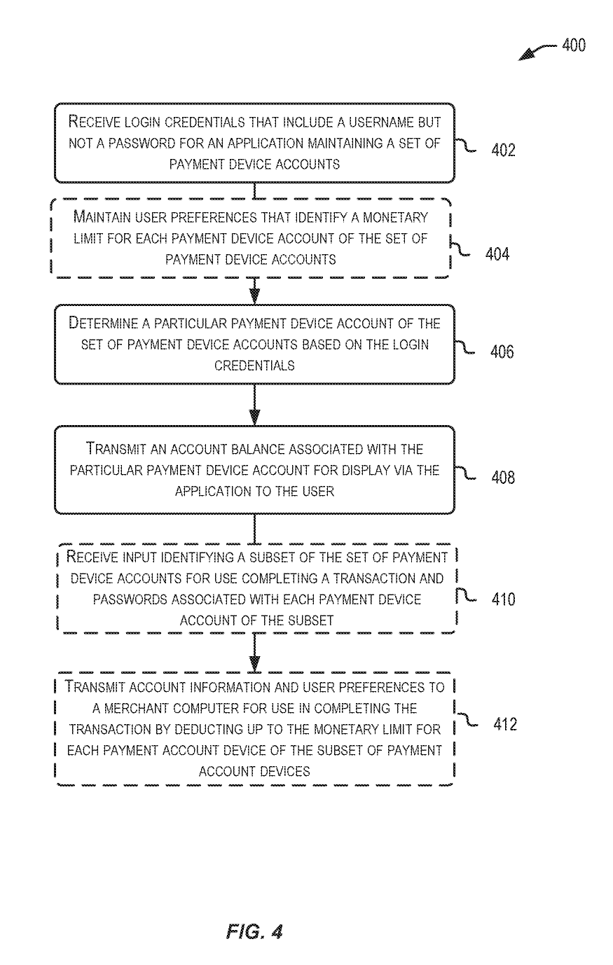

FIG. 4 depicts an example flow chart of an account balance feature, in accordance with at least one embodiment of the disclosure. This process is illustrated as a logical flow diagram, each operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer executable instructions include routines, programs, objects, components, data structures, and the like that perform particular functions or implement particular data types. The order in which the operations are described is not intended to be construed as a limitation, and any number of the described operations can be combined in any order and/or in parallel to implement the process.

Additionally, some, any, or all of the process (or any other processes described herein, or variations and/or combination thereof) may be performed under the control of one or more computer systems configured with executable instructions and may be implemented as code (e.g., executable instructions, one or more computer programs, or one or more applications) executing collectively on one or more processors, by hardware or combinations thereof. As noted above, the code may be stored on a computer-readable storage medium, for example, in the form of a computer program including a plurality of instructions executable by one or more processors. The computer-readable storage medium may be non-transitory. In some examples, the components of FIG. 1 may perform the process 400. Some of the steps or elements included in FIG. 4 may be optional and are represented by the dashed lines. In FIG. 4, the process 400 may include receiving login credentials that include a username but not a password for an application maintaining a set of payment device accounts at 402. For example, a user may interact with a wallet application of a mobile device by tactile touch, gesturing, or other suitable input mechanisms such as input/output (I/O) devices to select a payment account device and provide a username for said payment account device.

In some embodiments, the process 400 may include maintaining user preferences (e.g., in the wallet application server or the wallet application on the mobile device) for utilizing the various payment account devices. Such preferences may be specified by the user before any transaction is initiated with the payment account devices or when the payment account device(s) are being selected to conduct a transaction. For example, in some embodiments, such preferences may identify a monetary limit for each payment device account of the set of payment device accounts at 404. For example, during an initialization process or at a later time after setting up the wallet application of the mobile device to maintain information for the set of payment device accounts, the user may provide user preferences for each payment account device and these preferences may be stored in the wallet application 114. The user preferences may identify a monetary limit or upper monetary ceiling for which a transaction cannot exceed during completion of a transaction. Other preferences may identify which order to utilize the various payment account devices when multiple payment account devices are selected to complete a transaction. Another user preference may identify a monetary limit to apply to each payment account device when multiple payment account devices are selected. For example, during a transaction for a $300 purchase, a user preference may specify that $100 will be deducted from each of three payment account devices on the wallet application 114. Other user preferences may be specified for the payment account devices as described below with reference to FIG. 5. The process 400 may include determining one or more payment device accounts of the set of payment device accounts based on the login credentials at 406. For example, the wallet application server and/or payment processing network may maintain a database that associates unique usernames, passwords, login credentials, etc., with a corresponding payment account device. The servers or computers may then perform a look up operation using the username as a keyword to identify an appropriate payment account device and issuer that should be contacted to retrieve the corresponding account balance.

The process 400 may include transmitting an account balance associated with the particular payment device account for display via the application to the user at 408. For example, the wallet application server may communicate, via available networks such as the internet, the account balance for an appropriate payment account device to the wallet application for display to the user via the mobile device. In embodiments, the wallet application server and/or payment processing network may identify the appropriate issuer to request the account balance for a payment account device that was identified using the login credentials. For example, a database may store information that associates unique login credentials (i.e., username and/or passwords) with each payment device account and corresponding issuer.

In some embodiments, the process 400 may include receiving input identifying a subset of the set of payment device accounts for use in completing a transaction and passwords associated with each payment device account of the subset of payment device accounts at 410. For example, the user may interact with the wallet application to select one or more payment device accounts for use in completing a transaction with a merchant. In response to selecting the one or more payment device accounts, the user may be prompted to enter a password or other authentication information such as biometric information for use in enabling the payment device account to be authorized for use in completing the transaction.

In some embodiments, the process 400 may include transmitting account information and user preferences to a merchant computer for use in completing the transaction by deducting up to the monetary limit for each payment account device of the subset of payment account devices at 412. In embodiments, the wallet application of the mobile device may transmit appropriate account information such as a payment credential, token, or other information as well data that identifies the user preferences for the selected payment account devices to the merchant computer and access device so that the appropriate amount of funds from each payment account device is used to complete the transaction without violating the user preferences (e.g., deducting $100 from each payment account device to complete a $300 transaction). In embodiments, the wallet application of the user's mobile device may maintain user preferences which are also transmitted to the merchant computer, via the access device, along with the access data or account information enabling the merchant computer to appropriately deduct the appropriate funds from each payment account device or up to a monetary limit associated with each payment account device. In some embodiments, the user preferences may identify an order of payment device accounts to deduct from based on the selected payment device accounts.

In some embodiments, once the access device and/or merchant computer receives the payment account information and the preference information for the selected payment devices, the access device and/or merchant may process the payment using the preferences and the selection of the payment devices. For example, if the payment accounts selected include payment accounts A, B, and C, and the user's preference is to use the accounts in that order, then the access device or merchant computer (or a payment processor) can generate sequential authorization request messages to the issuers of payment accounts A, B, and C until the transaction is satisfied. For example, a transaction amount may be $300, and account A may have a $100 balance, account B may have a $150 balance, and account C may have a $400 balance. The access device and/or the merchant computer may receive account information for accounts A, B, and C (e.g., the account numbers or tokens, account balances, etc.) from the mobile device, and may generate a first authorization request message to the issuer of account A to obtain authorization for the balance of $100. It may also generate a second authorization request message to the issuer of account B to obtain authorization for the $150 balance. It may then generate a third authorization request message to the issuer of account C for $50, which is the remainder of the transaction amount. These authorization request messages may be transmitted in parallel or sequentially. At a later time, a clearing and settlement process can occur.

FIG. 5 depicts an example of a wallet application module for implementing at least some embodiments of the current disclosure. The wallet application module may be the same as the wallet application 114 of FIG. 1. It should be noted that while multiple modules are described and illustrated in the wallet application module 502, the processes and methods described herein can be performed by more or less modules within memory of corresponding user devices, mobile devices, or server computers. In addition, while the modules 502-512 are displayed and described as distinct modules, in some embodiments they may be included within one another to further facilitate methods and systems described herein. Also, it should be noted that the described processes and architectures described below can be performed either in real-time or in an offline mode prior to any user interaction. For example, account balances may be pushed or provided to the wallet application of the mobile device prior to the user providing an appropriate username but not password in the wallet application therefore preventing the display of the corresponding account balance until the user has provided an appropriate username.

In accordance with at least one embodiment, the wallet application module 502 may include an account balance submodule 504, a geographic location submodule 506, a user preferences submodule 508, a communication submodule 510, and an offer determination submodule 512 in communication with a payment device account database 514. In embodiments, the wallet application module 502 may be configured, along with account balance module 504, to generate and display a user interface that presents available payment account devices associated with the wallet application of a corresponding mobile device of a user, similar to 302 of FIG. 3. The wallet application module 502 and account balance submodule 504 may update to add more or remove particular payment account devices upon the user initializing or setting up other payment account devices to be maintained by the wallet application of the mobile device.

In accordance with at least one embodiment, the geographic location submodule 506 may be configured to obtain and transmit geographic location information of an associated mobile device to the wallet application server and/or payment processing network for use in authentication processes and/or offer generation processes. The geographic location submodule 506 may utilize appropriate sensors or devices such as GPS components to obtain geographic location information of the mobile device as it is used by the user within a physical space. The geographic location submodule 506 may be configured to transmit the obtained or captured geographic location information to the wallet application server or merchant computer during a transaction process.

In accordance with at least one embodiment, the user preferences submodule 508 may be configured to maintain, receive, and process user preferences requests from a user interacting with the wallet application of a mobile device. For example, the user preferences submodule 508 may query the user during an initialization step or set-up procedure to enable the user to specify certain preferences for varying transaction, monetary limits, order of preference for available payment device accounts, or restrictions to item categories for particular payment device accounts. For example, a particular user preference may indicate that a certain payment device account is to only be used for grocery or food category items but otherwise is not to be utilized for other item category transactions. In embodiments, the user preferences submodule 508 may communicate the user preferences to a merchant computer and/or access device for use in deducting the appropriate amount or prohibiting certain payment account devices from being utilized when completing a transaction. The user preferences may be stored as metadata in the account information or access data transmitted to the access device and/or merchant computer. In some embodiments, the user preferences may instruct the merchant computer to communicate with the wallet application server to identify the appropriate order of payment devices accounts to utilize in a transaction, whether the selected payment device account can be utilized to complete a transaction for a particular item category or at a particular location, monetary limits associated with each payment device account, or an order and monetary limit to deduct from each payment device account when multiple payment device accounts are provided to complete a transaction (e.g., deduct $200 from payment device account A, then $50 from payment device accounts B and C).

In accordance with at least one embodiment, the communication module 510 may be configured to communicate with the wallet application server, payment processing network, issuer computers, and/or merchant computer for retrieving account balances for payment account devices or enabling a payment account device of the wallet application to be utilized to complete a transaction. In embodiments, the communication module 510 and wallet application module 502 may interact with the payment device account database 514 to identify or determine an appropriate payment account device to request funds for based on the provided username (e.g., login credentials) from a user interacting with the wallet application of the mobile device. The communication module 510 and offer determination module 512 may communicate with an issuer to request and generate an offer from an issuer to associate with a particular payment account device to otherwise incentivize the user to utilize the particular payment account device to complete a transaction. The geographical location module 506 may also provide geographic location information to the offer determination module 512 and communication module 510 for determining an offer to present to the user that is appropriate based on their current location.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A computer-implemented method, comprising:
receiving, by a computer system and from a mobile device, first login credentials in response to a user interacting with the mobile device, the first login credentials being utilized to login to an application associated with a set of payment device accounts;
obtaining, by the computer system, a username but not a password included in the first login credentials;
determining, by the computer system, a particular payment device account of the set of payment device accounts based at least in part on the first login credentials; and
transmitting, by the computer system to the mobile device, an account balance associated with the particular payment device account for display via the application to the user.

2. The method of claim 1 further comprising displaying, by the application on the mobile device, an offer associated with the particular payment device account.

3. The computer-implemented method of claim 1, further comprising:
receiving, by the computer system and from the mobile device, second login credentials for the application associated with the set of payment device accounts;
obtaining the password included in the second login credentials; and
enabling the particular payment device account to be utilized to complete a transaction based at least in part on obtaining the password.

4. The computer-implemented method of claim 1, wherein the set of payment device accounts are associated with a set of preferences specified by the user for the set of payment device accounts.

5. The computer-implemented method of claim 4, wherein the set of preferences include an order of preference for each payment device account of the set of payment device accounts when completing a transaction.

6. The computer-implemented method of claim 4, wherein the set of preferences include corresponding item categories for each payment device account of the set of payment device accounts.

7. The computer-implemented method of claim 4, wherein the set of preferences indicate a monetary limit for each payment device account of the set of payment device accounts when completing a transaction.

8. The computer-implemented method of claim 7, further comprising transmitting, to a merchant computer, payment account information for a subset of the set of payment device accounts thereby enabling the merchant computer to withdraw a monetary amount up to the corresponding monetary limit for each payment device account of the subset of payment device accounts to complete the transaction.

9. A computer-implemented method, comprising:
obtaining, by a mobile device, first input corresponding to login credentials for an application associated with a set of payment device accounts;
identifying, by the mobile device, that a username but not a password is included in the first input;
requesting, by the mobile device from a server computer, an account balance associated with a particular payment device account of the set of payment device accounts based at least in part on the first input; and
displaying, by the mobile device via the application, the account balance associated with the particular payment device account.

10. The computer-implemented method of claim 9, further comprising displaying, via the application, an offer associated with the particular payment device account.

11. The computer-implemented method of claim 9, further comprising:
obtaining, by the mobile device, second input corresponding to the login credentials for the application associated with the set of payment device accounts;
identifying, by the mobile device, that the password is included in the second input; and
enabling, by the mobile device, the particular payment device account to be utilized to complete a transaction based at least in part on identifying that the password is included in the second input.

12. The computer-implemented method of claim 9, wherein the set of payment device accounts are associated with a set of preferences specified by a user associated with the mobile device, the set of preferences corresponding for the set of payment device accounts.

13. The computer-implemented method of claim 12, wherein the set of preferences include an order of preference for each payment device account of the set of payment device accounts when completing a transaction.

14. The computer-implemented method of claim 12, wherein the set of preferences include corresponding item categories for each payment device account of the set of payment device accounts.

15. The computer-implemented method of claim 12, wherein the set of preferences indicate a monetary limit for each payment device account of the set of payment device accounts when completing a transaction.

16. The computer-implemented method of claim 9, further comprising transmitting, by the mobile device to a merchant computer, payment account information for a subset of the set of payment device accounts thereby enabling the merchant computer to withdraw a monetary amount up to the corresponding monetary limit for each payment device account of the subset of payment device accounts to complete the transaction.

17. A computer server, comprising:
a processor; and
a memory including instructions that, when executed with the processor, cause the server computer to, at least:
receive, from an application of a mobile device, first login credentials that are utilized to login to the application that is associated with a set of payment device accounts;
determine that a username but not a password are included in the first login credentials;
identify a particular payment device account of the payment device accounts based at least in part on the first login credentials; and
transmit, to the application for display, an account balance associated with the particular payment device account.

18. The computer server of claim 17, further comprising:
receiving, from the application of the mobile device, geographic location information associated a location of the mobile device;
determining an offer based at least in part on the geographic location information and the particular payment device account; and
transmitting, to the application of the mobile device, the offer.

19. The computer server of claim 17, further comprising maintaining a set of preferences specified by a user associated with the mobile device for the set of payment device accounts, the set of preferences identifying monetary limitations for each payment device account of the set of payment device accounts corresponding to geographic locations.

20. The computer server of claim 19, further comprising transmitting a certain amount of funds from the particular payment device account based at least in part on geographic location information associated with a transaction and the set of preferences.
